(19) United States
(12) Patent Application Publication
(10) Pub. No.: US 2024/0202750 A1
(43) Pub. Date: Jun. 20, 2024

(54) SYSTEMS AND METHODS FOR GENERATING REVENUE FORECASTS

(71) Applicant: Dell Products L.P., Round Rock, TX (US)

(72) Inventors: Pratik Jain, Bengaluru (IN); Anna V. Popova, Murphy, TX (US); Vinod Babu Palani, Leander, TX (US)

(21) Appl. No.: 18/083,101

(22) Filed: Dec. 16, 2022

(51) Int. Cl. G06Q 30/0202; G06N 5/04

(52) U.S. Cl. CPC G06Q 30/0202; G06N 5/04

(57) ABSTRACT

A method for generating composite prediction data, the method that includes obtaining, by a computing device, conventional prediction data based on historical revenue data, generating first distributed prediction data, using a first distributed model, based on first sales pipeline data, and obtaining a composite prediction data by aggregating the conventional prediction data and the first distributed prediction data.

### BACKGROUND

Devices are often capable of performing certain functionalities that other devices are not configured to perform, or are not capable of performing. In such scenarios, it may be desirable to adapt one or more systems to enhance the functionalities of devices that cannot perform those functionalities.

### BRIEF DESCRIPTION OF DRAWINGS

FIG. 1 shows a diagram of a virtualized system, in accordance with one or more embodiments.

FIG. 2A shows a diagram of a revenue database, in accordance with one or more embodiments.

FIG. 2B shows a diagram of a sales pipeline database, in accordance with one or more embodiments.

FIG. 2C shows a diagram of a conventional model database, in accordance with one or more embodiments.

FIG. 2D shows a diagram of a conventional forecast database, in accordance with one or more embodiments.

FIG. 2E shows a diagram of a distributed model database, in accordance with one or more embodiments.

FIG. 2F shows a diagram of a distributed forecast database, in accordance with one or more embodiments.

FIG. 2G shows a diagram of a composite forecast database, in accordance with one or more embodiments.

FIG. 3A shows a flowchart of a method for standardizing revenue data, in accordance with one or more embodiments.

FIG. 3B shows a flowchart of a method for generating conventional prediction data, in accordance with one or more embodiments.

FIG. 4 shows a flowchart of a method for generating distributed and composite prediction data, in accordance with one or more embodiments.

FIG. 5 shows a diagram of a network and computing device, in accordance with one or more embodiments.

### DETAILED DESCRIPTION

### General Notes

As it is impracticable to disclose every conceivable embodiment of the described technology, the figures, examples, and description provided herein disclose only a limited number of potential embodiments. One of ordinary skill in the art would appreciate that any number of potential variations or modifications may be made to the explicitly disclosed embodiments, and that such alternative embodiments remain within the scope of the broader technology. Accordingly, the scope should be limited only by the attached claims. Further, certain technical details, known to those of ordinary skill in the art, may be omitted for brevity and to avoid cluttering the description of the novel aspects.

For further brevity, descriptions of similarly-named components may be omitted if a description of that similarly-named component exists elsewhere in the application. Accordingly, any component described with regard to a specific figure may be equivalent to one or more similarly-named components shown or described in any other figure, and each component incorporates the description of every similarly-named component provided in the application (unless explicitly noted otherwise). A description of any component is to be interpreted as an optional embodiment-which may be implemented in addition to, in conjunction with, or in place of an embodiment of a similarly-named component described for any other figure.

### Lexicographical Notes

As used herein, adjective ordinal numbers (e.g., first, second, third, etc.) are used to distinguish between elements and do not create any particular ordering of the elements. As an example, a “first element” is distinct from a “second element”, but the “first element” may come after (or before) the “second element” in an ordering of elements. Accordingly, an order of elements exists only if ordered terminology is expressly provided (e.g., “before”, “between”, “after”, etc.) or a type of “order” is expressly provided (e.g., “chronological”, “alphabetical”, “by size”, etc.). Further, use of ordinal numbers does not preclude the existence of other elements. As an example, a “table with a first leg and a second leg” is any table with two or more legs (e.g., two legs, five legs, thirteen legs, etc.). A maximum quantity of elements exists only if express language is used to limit the upper bound (e.g., “two or fewer”, “exactly five”, “nine to twenty”, etc.). Similarly, singular use of an ordinal number does not imply the existence of another element. As an example, a “first threshold” may be the only threshold and therefore does not necessitate the existence of a “second threshold”.

As used herein, the word “data” is used as an “uncountable” singular noun—not as the plural form of the singular noun “datum”. Accordingly, throughout the application, “data” is generally paired with a singular verb (e.g., “the data is modified”). However, “data” is not redefined to mean a single bit of digital information. Rather, as used herein, “data” means any one or more bit(s) of digital information that are grouped together (physically or logically). Further, “data” may be used as a plural noun if context provides the existence of multiple “data” (e.g., “the two data are combined”).

As used herein, the term “operative connection” (or “operatively connected”) means the direct or indirect connection between devices that allows for interaction in some way (e.g., via the exchange of information). For example, the phrase ‘operatively connected’ may refer to a direct connection (e.g., a direct wired or wireless connection between devices) or an indirect connection (e.g., multiple wired and/or wireless connections between any number of other devices connecting the operatively connected devices).

### Overview and Advantages

In general, this application discloses one or more embodiments of systems and methods for more accurately generating revenue forecasts using multiple analytic techniques that are specially adapted to subset categories of the provided data (e.g., are “distributed”). The distributed prediction data is then used to generate more accurate composite prediction data for the revenue forecast.

Predicting revenue accurately can be a challenge for businesses around the world. Rapidly changing economic conditions, supply chain disruptions, and rising inflation can all impact a business's ability to forecast its revenue with precision. In order to have a comprehensive view of the potential risks to meeting revenue targets, businesses need to consider the diverse environments in different business segments and the sales behavior in different territories.

In general, as a business operates, revenue and margin are generated and tracked in “quarters” of the year (a three-month period). Accordingly, much of the determination of potential risks and opportunities are identified and tracked “by quarter”. This evaluation often revolves around key issues, such as: (i) estimating how much revenue is likely to be generated by the end of the quarter, (ii) identifying sales that diverge from their estimated revenue, (iii) attainment (revenue divided by revenue target), (iv) identifying the risks in meeting the revenue target, (v) estimating demand in the pipeline to meet the revenue target, and (vi) in the event of a risk, quantifying the additional demand needed to mitigate the identified risks.

Often businesses already measure and store a vast amount of data that can provide significant insight into the ongoing operations of the business (and the aid the evaluation of the above-mentioned factors). By applying data science techniques to this data, businesses can extract revenue trends and patterns and use them to better predict revenue (e.g., generate more accurate forecasts), thereby helping sales teams to be better prepared to handle potential gaps in meeting revenue targets.

Data can also be used to predict revenue that is sensitive to changes in macro trends. This can be particularly useful in an uncertain economic climate, where global events can quickly impact a business's revenue streams. By leveraging data science techniques, businesses can model the best, worst, and likely scenarios of revenue attainment-thereby providing a more comprehensive view of the potential risks and opportunities they may face.

Further, engineering this data can help businesses derive quantitative factors impacting revenue. By understanding the key factors that drive revenue, businesses can make better informed decisions about how to mitigate potential risks and capitalize on opportunities. This data can also be wielded to quantify risk and risk mitigation measures, allowing businesses to better understand the potential impact of different risks and how to address those risks.

The critical data elements that are most actionable for sales risk mitigation activities vary depending on the specific business and its operations. However, by identifying the data elements that are most relevant to the business, sales teams can be better equipped to handle potential risks and work towards meeting revenue targets.

In addition to the factors mentioned above, the complexity of products, segment hierarchy, and sales team attributes can all play a role in revenue prediction. By taking these factors into account, businesses can develop a more comprehensive and accurate picture of their potential revenue and risks. For example, businesses with complex products may face unique challenges in predicting revenue, as the sales process for these products may be more difficult to model. Similarly, the hierarchy of a business's segments and the attributes of its sales teams can impact revenue prediction, and these factors should be considered when forecasting revenue.

Overall, accurately predicting revenue is a critical task for businesses, and data science can play a crucial role in helping businesses to better understand and manage the risks to their revenue targets. By leveraging data to extract revenue trends and patterns, model different scenarios, and derive quantitative factors impacting revenue, businesses can be better prepared to handle the challenges they may face and work towards meeting their revenue targets.

Provided the issues discussed above, one or more embodiments herein describe a data science-based solution that provides sales teams the ability to proactively identify revenue target attainment risks, and further provide them key factors that drive the risk. The model described herein utilizes conventional historical revenue data in addition to metrics of the sales pipeline, such as deal size and conversion rates, to more accurately forecast revenue. Further, the model considers different types of revenue, such as bids and run-rate, to more precisely identify which revenue sources may be leading or lagging. The model is also designed to minimize errors by using a set of sub-models that extract maximum information from the data and align with a business perspective of revenue and pipeline.

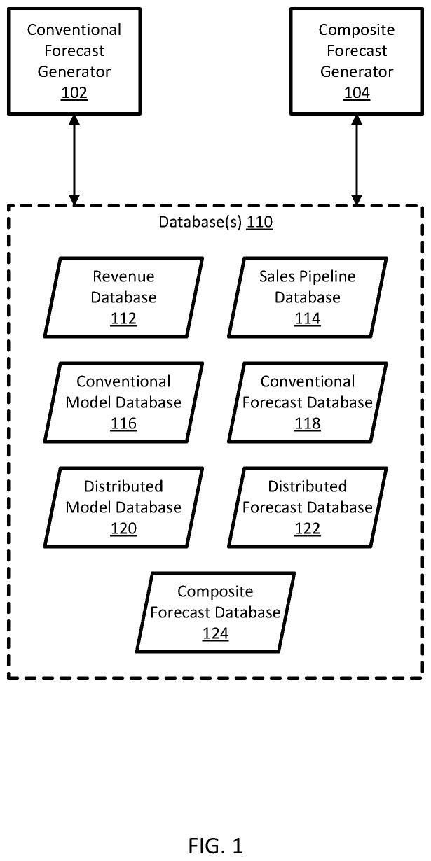

### FIG. 1

FIG. 1 shows a diagram of a virtualized system, in accordance with one or more embodiments. In one or more embodiments, a virtualized system may include one or more software entities (e.g., a conventional forecast generator (102), composite forecast generator (104)) and one or more database(s) (110). Each of these components is described below.

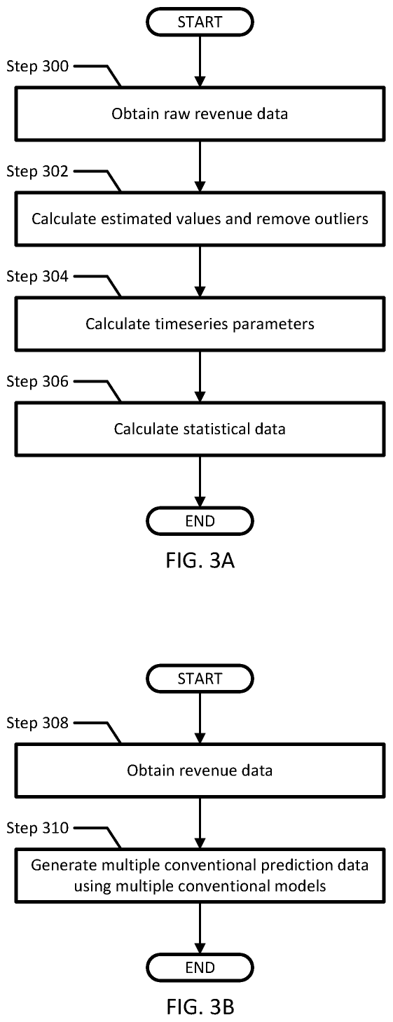

In one or more embodiments, a conventional forecast generator (102) is software, executing on a computing device, which generates conventional forecast data (in the conventional forecast database (118)) by using one or more conventional models (from the conventional model database (116)) to analyze revenue data (from the revenue database (112)). Additional details regarding the functions of the conventional forecast generator (102) may be found in the description of FIG. 3B.

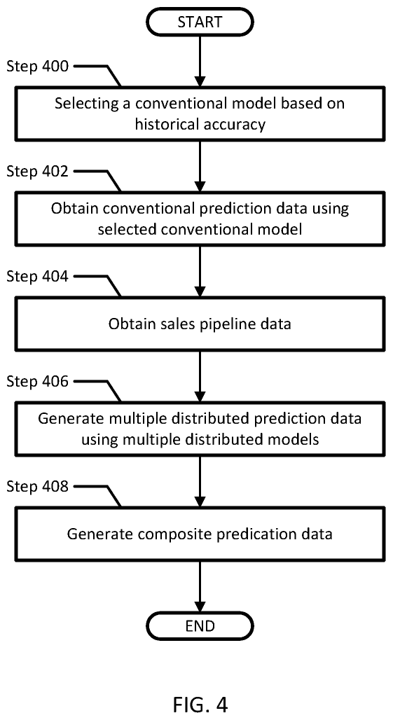

In one or more embodiments, a composite forecast generator (104) is software, executing on a computing device, which generates composite forecast data (in the composite forecast database (124)) using two or more distributed models (from the distributed model database (120)) to analyze revenue data (from the revenue database (112)), conventional forecast data (in the conventional forecast database (118)), and sales pipeline data (from the sales pipeline database (114)). Additional details regarding the functions of the composite forecast generator (104) may be found in the description of FIG. 3A and FIG. 4.

In one or more embodiments, a database (e.g., database(s) (110)) is a collection of data stored on a computing device, which may be grouped (physically or logically). Non-limiting examples of a database (110) include a revenue database (112), a sales pipeline database (114), a conventional model database (116), a conventional forecast database (118), distributed model database (120), distributed forecast database (122), and a composite forecast database (124).

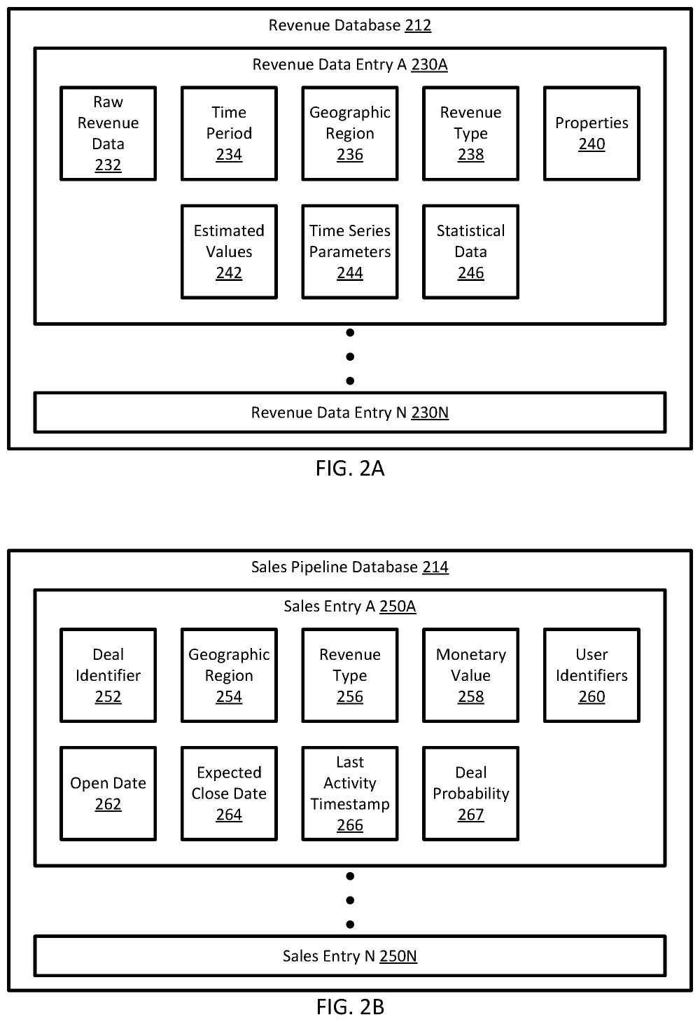

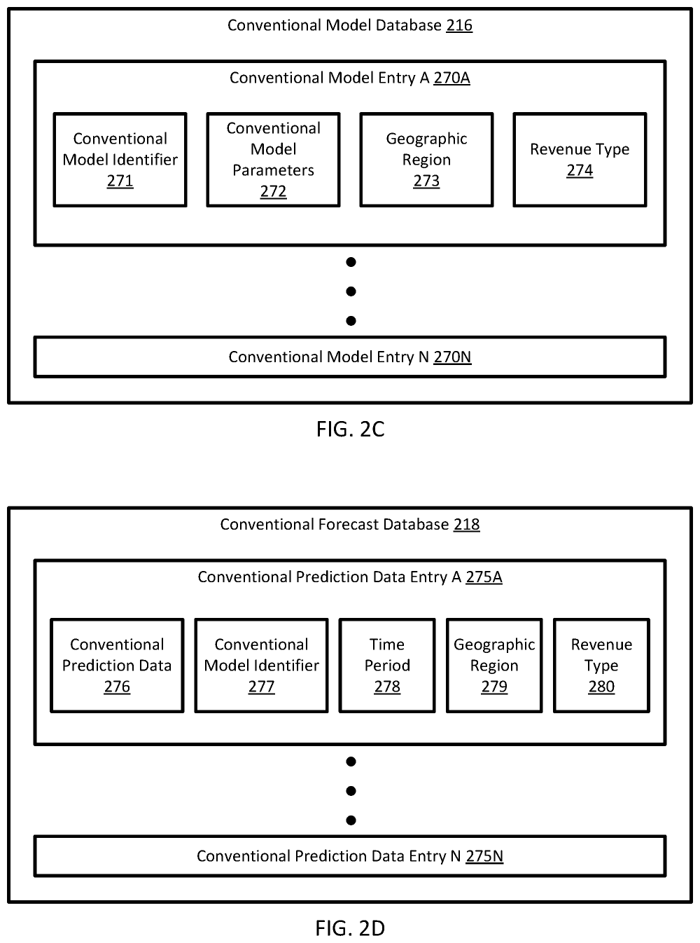

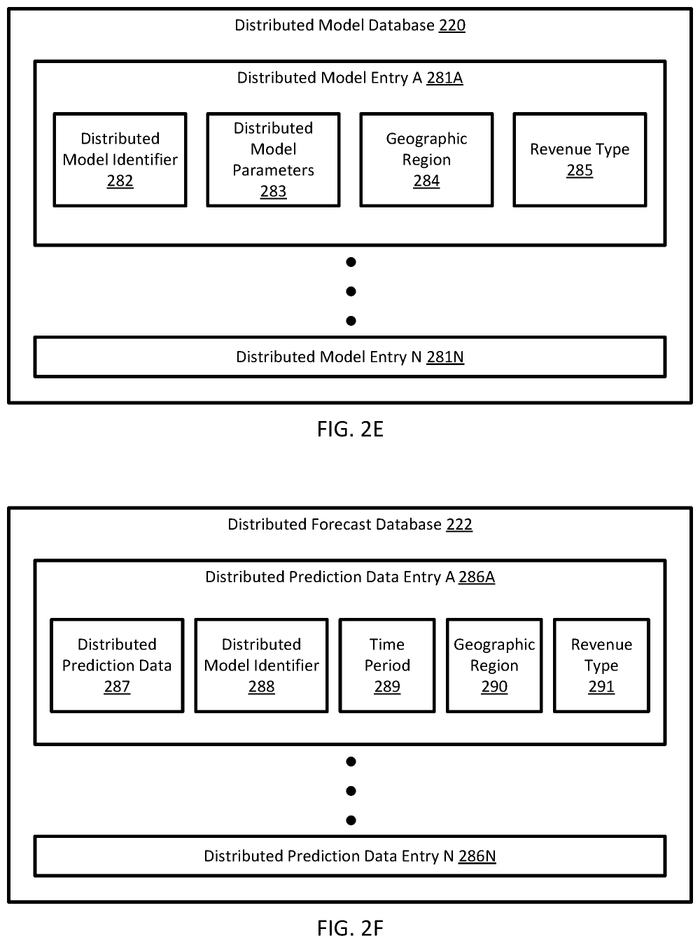

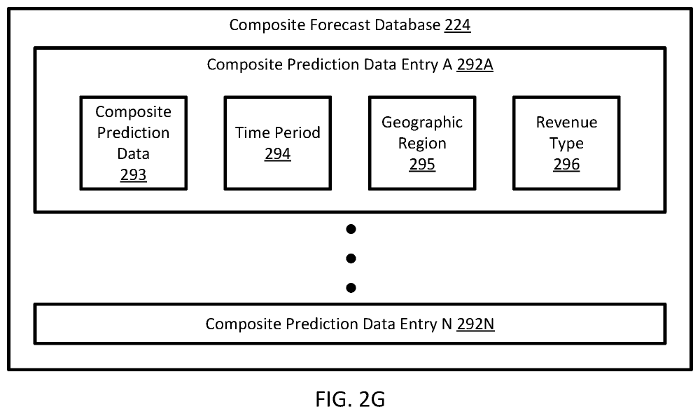

Although the databases (110) are shown as seven distinct databases, any combination of two or more of the seven databases (110) may be combined into a single database (not shown) that includes some or all of the data of any of the individual databases. Additional details regarding the individual databases (110) may be found in the description of FIGS. 2A-2G.

While a specific configuration of a system is shown, other configurations may be used without departing from the disclosed embodiment. Accordingly, embodiments disclosed herein should not be limited to the configuration of devices and/or components shown.

### FIG. 2A

FIG. 2A shows a diagram of a revenue database, in accordance with one or more embodiments. In one or more embodiments, a revenue database (212) is a data structure that includes one or more revenue data entries (e.g., revenue data entry A (230A), revenue data entry N (230N)). In one or more embodiments, a revenue data entry (230) is a data structure that may include (or otherwise be associated with):
(i) raw revenue data (232) (explained below),
(ii) a time period (234) that provides a date/time range for the raw revenue data. In one or more embodiments, the time period may be set by taking the earliest and latest timestamps in the raw revenue data (232) (e.g., January 1 to December 31, 17:00 to 18:45, 1669830702 to 1669837902). In one or more embodiments, the time period (234) may be a complete array of timestamps corresponding to all data in the raw revenue data (232),
(iii) a geographic region (236) that indicates the geographic territory associated with the raw revenue data (232) (e.g., North America (NA), Asia-Pacific-Japan (APJ), Texas, Paris, 123 main street, etc.). As a non-limiting example, if the geographic region is “India”, the raw revenue data (232) would pertain to revenue emanating from India,
(iv) a revenue type (238) relating the category of revenue associated with the raw revenue data (232) (e.g., retail, enterprise sales, run rate, bid size, etc.),
(v) properties (240) that includes any other metadata relating to the raw revenue data (232),
(vi) estimated values (242) (e.g., interpolated, extrapolated, etc.) that are calculated to supplement missing values in the raw revenue data (232),
(vii) timeseries parameters (244) that are derived from the raw revenue data (232) by performing one or more analyses (e.g., seasonal decomposition, Ljung-Box test for stationarity, white noise test, etc.). Further the timeseries parameters (244) may include the ‘Q’ and ‘P’ parameters for a seasonal autoregressive integrated moving average (ARIMA) calculated using autocorrelation,
(viii) statistical data (246) that includes one or more arrays of statistical analysis (e.g., any n-period exponential moving average (EMA), any n-period simple moving average (SMA), moving average convergence-divergence (MACD), last-four-quarters (L4Q) average, quantiles, lagged revenues (time shifted revenue variables to indicate seasonality), seasonally-adjusted revenues (removing seasonal trends to show only underlying trends)), or
(ix) any combination thereof.

In one or more embodiments, raw revenue data (232) is data that includes information recorded and collected from past events. In one or more embodiments, each piece of information in the raw revenue data (232) is associated with a specific time (e.g., in the raw revenue data (232) and/or a timestamp in the time period (234)). Raw revenue data (232) may be organized based on the type of information (e.g., based on the associated revenue type (238)) and/or based on a time range (e.g., 2020, July, Saturday). Raw revenue data (232) may take the form of “timeseries” data that, over time, form discernable patterns in the underlying data. In the context of business and revenue forecasting, non-limiting examples of raw revenue data (232) include (i) sales revenue of past transactions, (ii) a quantity of items sold/shipped/paid for, and/or (iii) any other data that may be collected, measured, or calculated for business purposes.

In one or more embodiments, as used herein, “revenue data” means the data within any one revenue data entry (230).

### FIG. 2B

FIG. 2B shows a diagram of a sales pipeline database, in accordance with one or more embodiments. In one or more embodiments, a sales pipeline database (214) is a data structure that includes one or more sales entries (e.g., sales entry A (250A), sales entry N (250N)). In one or more embodiments, a sales entry (250) is a data structure that may include (or otherwise be associated with):
(i) a deal identifier (252) that uniquely identifies a single deal associated with the sales entry (250) (non-limiting examples of an identifier include a tag, an alphanumeric entry, a filename, and a row number in table),
(ii) a geographic region (254) (same description as region (236)),
(iii) a revenue type (256) (same description as revenue type (238)),
(iv) a monetary value (258) that equals the potential revenue that would be generated if the deal associated with the sales entry (250) is fulfilled,
(v) user identifier(s) (260) that uniquely identifies one or more user account(s) that are able to access (read) and/or edit (write) the associated sales entry (250),
(vi) an open date (262) that is the date/time when the deal associated with the sales entry (250) was initiated (e.g., when a bid was offered, when a request-for-quote was received, etc.). In one or more embodiments, the open date (262) may be the date/time when the sales entry (250) was created,
(vii) an expected close date (264) that is the date/time when the potential deal associated with the sales entry (250) is expected to “close” (i.e., receive a commitment to purchase from the buyer),
(viii) a last activity timestamp (266) that is the date/time when the last action for the deal was performed (e.g., an initial bid, an updated quote request, a notice that the seller is advancing in the bid process, etc.). In one or more embodiments, the last activity timestamp (266) may be set at the last time the sales entry (250) (e.g., any data therein) was modified (e.g., updated),
(ix) a deal probability (267) that represents the likelihood that the deal will “close” (which may be calculated or input by a human), or
(x) any combination thereof.

In one or more embodiments, as used herein, “sales pipeline data” means the data within any one sales entry (250).

### FIG. 2C

FIG. 2C shows a diagram of a conventional model database, in accordance with one or more embodiments. In one or more embodiments, a conventional model database (216) is a data structure that includes one or more conventional model entries (e.g., conventional model entry A (270A), conventional model entry N (270N)). In one or more embodiments, a conventional model entry (270) is a data structure that may include (or otherwise be associated with):
(i) a conventional model identifier (271) that uniquely identifies a conventional model associated with the conventional model entry (270),
(ii) a set of conventional model parameters (272) (described below),
(iii) a geographic region (273) (same description as region (236)),
(iv) a revenue type (274) (same description as revenue type (238)), or
(v) any combination thereof.

In one or more embodiments, conventional model parameters (272) provide instructions (to the conventional forecast generator) on how to calculate conventional prediction data (276). The conventional model parameters (272) may specify one or more univariate time series analysis techniques including (i) Prophet, (ii) seasonal autoregressive integrated moving average (SARIMA), (iii) TBATS (trigonometric seasonality, box-cox transformation, ARMA errors, trend, seasonal components), (iv) time series linear model (TSLM), or multivariate techniques (long short-term memory (LSTM)).

In one or more embodiments, as used herein, “conventional model” means the data within any one conventional model entry (270).

### FIG. 2D

FIG. 2D shows a diagram of a conventional forecast database, in accordance with one or more embodiments. In one or more embodiments, a conventional forecast database (218) is a data structure that includes one or more conventional prediction data entries (e.g., conventional prediction data entry A (275A), conventional prediction data entry N (275N)). In one or more embodiments, a conventional prediction data entry (275) is a data structure that may include (or otherwise be associated with):
(i) conventional prediction data (276) (described below),
(ii) a conventional model identifier (277) (same description as conventional model identifier (271)),
(iii) a time period (278) (same description as time period (234)),
(iv) a geographic region (279) (same description as geographic region (236)),
(v) a revenue type (280) (same description as revenue type (238)), or
(vi) any combination thereof.

In one or more embodiments, conventional prediction data (276) is data generated by the conventional forecast generator using one or more conventional model(s) techniques on the revenue data. To generate the conventional prediction data (276), the conventional forecast generator uses the conventional model parameters (272) available in the conventional model entry (270) to perform the specified operations on the revenue data (e.g., performs a SARIMA operation on the revenue data to obtain the conventional prediction data (276)).

### FIG. 2E

FIG. 2E shows a diagram of a distributed model database, in accordance with one or more embodiments. In one or more embodiments, a distributed model database (220) is a data structure that includes one or more distributed model entries (e.g., distributed model entry A (281A), distributed model entry N (281N)). In one or more embodiments, a distributed model entry (281) is a data structure that may include (or otherwise be associated with):
(i) a distributed model identifier (282) that uniquely identifies a distributed model associated with the distributed model entry (281),
(ii) a set of distributed model parameters (283) (described below),
(iii) a geographic region (284) (same description as region (236)),
(iv) a revenue type (285) (same description as revenue type (238)), or
(v) any combination thereof.

In one or more embodiments, distributed model parameters (283) provide instructions to the composite forecast generator on how to calculate distributed prediction data (287). The distributed model parameters (283) may specify a machine learning algorithm (e.g., distributed random forest, a neural network, logistic regression) or more standard curve fitting techniques (e.g., logistic growth curve) to use when calculating the distributed prediction data (287).

In one or more embodiments, the distributed model parameters (283) specify using only certain properties of a sales entry (250) when performing the analysis. As a non-limiting example, the distributed model parameters (283) may specify using only monetary value (258) and “weighted” monetary value (multiplying the monetary value (258) by the deal probability (267)). As another non-limiting example, the distributed model parameters (283) may specify using only conversion rates (the historical rate of revenue from pipeline orders). Accordingly, only certain subsets of data are used when calculating the distributed prediction data (287).

In one or more embodiments, as used herein, “distributed model” means the data within any one distributed model entry (281).

### FIG. 2F

FIG. 2F shows a diagram of a distributed forecast database, in accordance with one or more embodiments. In one or more embodiments, a distributed forecast database (222) is a data structure that includes one or more distributed prediction data entries (e.g., distributed prediction data entry A (286A), distributed prediction data entry N (286N)). In one or more embodiments, a distributed prediction data entry (286) is a data structure that may include (or otherwise be associated with):
(i) distributed prediction data (287) (described below),
(ii) a distributed model identifier (288) (same description as distributed model identifier (282)),
(iii) a time period (289) (same description as time period (234)),
(iv) a geographic region (290) (same description as geographic region (236)),
(v) a revenue type (291) (same description as revenue type (238)), or
(vi) any combination thereof.

In one or more embodiments, distributed prediction data (287) is data generated by the composite forecast generator using one or more distributed model techniques on the revenue data. To generate the distributed prediction data (287), the composite forecast generator uses the distributed model parameters (283) available in the distributed model entry (281) to perform the specified operations on the revenue data (e.g., performs a distributed random forest algorithm using only the monetary value (258) and the open date (262) to obtain the distributed prediction data (287)).

### FIG. 2G

FIG. 2G shows a diagram of a composite forecast database, in accordance with one or more embodiments. In one or more embodiments, a composite forecast database (224) is a data structure that may include one or more composite prediction data entries (e.g., composite prediction data entry A (292A), composite prediction data entry N (292N)). In one or more embodiments, a composite prediction data entry (292) is a data structure that may include (or otherwise be associated with):
(i) composite prediction data (293) (described below),
(ii) a time period (294) (same description as time period (234)),
(iii) a geographic region (295) (same description as geographic region (236)),
(iv) a revenue type (296) (same description as revenue type (238)), or
(v) any combination thereof.

In one or more embodiments, composite prediction data (293) is data generated by the composite forecast generator by combining two or more distributed prediction data (287) using weighted averaging. In one or more embodiments, the weights assigned to each distributed prediction data (287) are calculated using revenue data of the same analysis to determine past accuracy, then applying some technique (e.g., ordinary least squares (OLS)) to calculate the assigned weight.

### FIG. 3A

FIG. 3A shows a flowchart of a method for standardizing revenue data, in accordance with one or more embodiments. All or a portion of the method shown may be performed by one or more components of the virtual system (e.g., the conventional forecast generator and the composite forecast generator and the executor). However, another component of the virtual system may perform this method without departing from the embodiments disclosed herein. While the various steps in this flowchart are presented and described sequentially, one of ordinary skill in the relevant art (having the benefit of this detailed description) would appreciate that some or all of the steps may be executed in different orders, combined, or omitted, and some or all steps may be executed in parallel.

In Step 300, the conventional forecast generator obtains raw revenue data from the revenue database (or from the source computing device(s) from which the raw revenue data originates). Further, once obtained, the forecast generator obtains stores (i.e., saves, writes) the raw revenue data to the revenue database (if not stored there already). In one or more embodiments, the conventional forecast generator may obtain raw revenue data at regular intervals (e.g., every 10 milliseconds, 1 minute, 5 hours, etc.). The conventional forecast generator may obtain the raw revenue data via an application programming interface (API) provided by the revenue database (or source computing device(s)).

In Step 302, the conventional forecast generator calculates estimated values for missing data and removes outliers in the raw revenue data. In one or more embodiments, the raw revenue data may fail to include data for every instance where data should have been recorded (e.g., caused by human-error, technical issues, data corruption, etc.). Consequently, raw revenue data is likely to be less useful for analysis with “null” values sprinkled throughout. Accordingly, such missing values are calculated using one or more techniques (e.g., interpolation, extrapolation, averaging, etc.) to fill those empty values. Additionally, in one or more embodiments, outlying data is identified and removed using one or more techniques. In one or more embodiments, the conventional forecast generator saves the estimated values to the revenue database.

In Step 304, the conventional forecast generator calculates time series parameter(s) for the raw revenue data. To calculate the time series parameters, the conventional forecast generator may use one or more techniques (e.g., seasonal decomposition, Ljung-Box test for stationarity, white noise test, etc.). Further, the time series parameters may include the maximum lag (P), largest insignificant lag (Q), and differences (D) for seasonal (and non-seasonal) ARIMA. In one or more embodiments, the conventional forecast generator saves the time series parameter(s) to the revenue database.

In Step 306, the conventional forecast generator calculates the statistical data for the raw revenue data. Non-limiting examples of statistical data include (i) any n-period EMA, (ii) any n-period SMA, (iii) a MACD, (iv) an L4Q average, (v) quantiles, (vi) lagged revenues, and (vii) seasonally-adjusted revenues. In one or more embodiments, the conventional forecast generator saves the time series parameter(s) to the revenue database.

### FIG. 3B

FIG. 3B shows a flowchart of a method for generating conventional prediction data, in accordance with one or more embodiments. All or a portion of the method shown may be performed by one or more components of the virtual system (e.g., the conventional forecast generator and the composite forecast generator and the executor). However, another component of the virtual system may perform this method without departing from the embodiments disclosed herein. While the various steps in this flowchart are presented and described sequentially, one of ordinary skill in the relevant art (having the benefit of this detailed description) would appreciate that some or all of the steps may be executed in different orders, combined, or omitted, and some or all steps may be executed in parallel.

In Step 308, the conventional forecast generator obtains revenue data (e.g., all data in a revenue data entry) from the revenue database. In one or more embodiments, the conventional forecast generator may obtain revenue data at regular intervals (e.g., every 10 milliseconds, 1 minute, 5 hours, etc.). The conventional forecast generator may obtain the raw revenue data via an application programming interface (API) provided by the revenue database (or source computing device(s)).

In Step 310, the conventional forecast generator generates multiple conventional prediction datasets using multiple (respective) conventional models. As a non-limiting example, for any individual revenue data entry, the conventional forecast generator generates a first set of conventional prediction data using SARIMA, then generates a second set of conventional prediction data (for the same revenue data entry) using TBATS, then generates a third set of conventional prediction data (for the same revenue data entry) using TSLM, etc. Accordingly, a variety of conventional prediction datasets (each using different techniques) are available for the same underlying revenue data entry.

### FIG. 4

FIG. 4 shows a flowchart of a method for generating distributed and composite prediction data, in accordance with one or more embodiments. All or a portion of the method shown may be performed by one or more components of the virtual system (e.g., the conventional forecast generator and the composite forecast generator and the executor). However, another component of the virtual system may perform this method without departing from the embodiments disclosed herein. While the various steps in this flowchart are presented and described sequentially, one of ordinary skill in the relevant art (having the benefit of this detailed description) would appreciate that some or all of the steps may be executed in different orders, combined, or omitted, and some or all steps may be executed in parallel.

In Step 400, the composite forecast generator selects a conventional model that is most accurate for a provided time period. In one or more embodiments, the composite forecast generator compares each type of previously-generated conventional prediction dataset (for a provided geographic region, revenue type, and time period) against now-known revenue data to determine which conventional model was most accurate. The conventional prediction data with the lowest percent error is identified and the conventional model associated with that model (via the conventional model parameters) is selected.

As a non-limiting example, the composite forecast generator obtains the revenue data entry for the prior week (now having known, recorded data available). The composite forecast generator then obtains each of the conventional prediction datasets that were generated for the prior week's revenue (e.g., generated two weeks prior). An error calculation is then made for each of the conventional prediction datasets (e.g., Prophet, SARIMA, TBATS, TSLM, LSTM) to identify which conventional prediction data was the most accurate (having the lowest error). Continuing with the example, the composite forecast generator identifies that the conventional prediction data using the TBATS parameters has the lowest error. Accordingly, the TBATS model is selected.

In Step 402, the composite forecast generator obtains conventional prediction data for a future time period (e.g., next week), where the conventional prediction data was generated using selected conventional model (e.g., TBATS). In one or more embodiments, the composite forecast generator identifies the conventional prediction data (generated using selected conventional model) in the conventional forecast database by matching the conventional model parameters and the specified time period. In one or more embodiments, the obtained conventional prediction data was already generated by the conventional forecast generator (see FIG. 3B), or the composite forecast generator may generate the conventional prediction data independently.

In Step 404, the composite forecast generator obtains sales pipeline data (e.g., all data in a sales entry) from the sales pipeline database. In one or more embodiments, the composite forecast generator obtains sales entry that matches the same future time period (e.g., next week) and geographic region as the obtained conventional prediction data.

In Step 406, the composite forecast generator generates multiple distributed prediction datasets using multiple (respective) distributed models for each of the obtained sales pipeline data (i.e., multiple sales entries) matching the future time period. In one or more embodiments, the composite forecast generator generates distributed prediction data for each of the distributed model entries that matches the geographic region and revenue type.

As a non-limiting example, for any individual revenue data entry, the composite forecast generator generates a first set of distributed prediction data using a distributed random forest algorithm on a subset of the sales entry data (conversion and monetary value). Then, the composite forecast generator generates a second set of distributed prediction data using a distributed random forest algorithm on a different subset of the sales entry data (deal probability and open date). Then, the composite forecast generator generates a third set of distributed prediction data using a LSTM algorithm on a different subset of the sales entry data (revenue type).

In Step 408, the composite forecast generator generates composite prediction data. In one or more embodiments, the composite forecast generator combines (i.e., aggregates) each of the distributed prediction datasets (generated in Step 406) and the conventional prediction data (obtained in Step 402) using weighted averaging. In one or more embodiments, the composite forecast generator assigns weights to each distributed model and the used conventional model, where the weights are calculated using past accuracy (e.g., applying some technique (e.g., ordinary least squares (OLS)) to calculate the assigned weight). After the weight of each of the distributed prediction datasets is known, all of the distributed prediction datasets are averaged together (with the conventional prediction data) to produce the single combined composite prediction data.

In one or more embodiments, the composite prediction data may be a single number (e.g., estimated weekly revenue is $5,141,063) or an array of data predicting revenue are multiple points in the future. In one or more embodiments, the composite prediction data is presented to a user of the sales pipeline so that such data is used for forecasting.

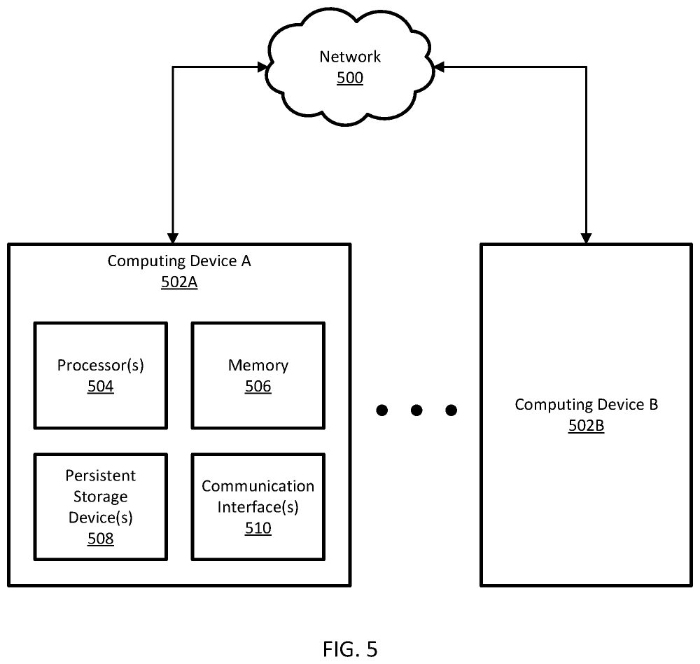

### FIG. 5

FIG. 5 shows a diagram of a network and computing device, in accordance with one or more embodiments. In one or more embodiments, a system may include a network (500) and one or more computing device(s) (502). Each of these components is described below.

In one or more embodiments, a network (e.g., network (500)) is a collection of connected network devices (not shown) that allow for the communication of data from one network device to other network devices, or the sharing of resources among network devices. Non-limiting examples of a network (e.g., network (500)) include a local area network (LAN), a wide area network (WAN) (e.g., the Internet), a mobile network, any combination thereof, or any other type of network that allows for the communication of data and sharing of resources among network devices and/or computing devices (502) operatively connected to the network (500). One of ordinary skill in the art, having the benefit of this detailed description, would appreciate that a network is a collection of operatively connected computing devices that enables communication between those computing devices.

In one or more embodiments, a computing device (e.g., computing device A (502A), computing device B (502B)) is hardware that includes any one, or combination, of the following components:
(i) processor(s) (504),
(ii) memory (506) (volatile and/or non-volatile),
(iii) persistent storage device(s) (508),
(iv) communication interface(s) (510) (e.g., network ports, small form-factor pluggable (SFP) ports, wireless network devices, etc.),
(v) internal physical interface(s) (e.g., serial advanced technology attachment (SATA) ports, peripheral component interconnect (PCI) ports, PCI express (PCIe) ports, next generation form factor (NGFF) ports, M.2 ports, etc.),
(vi) external physical interface(s) (e.g., universal serial bus (USB) ports, recommended standard (RS) serial ports, audio/visual ports, etc.),
(vii) input and output device(s) (e.g., mouse, keyboard, monitor, other human interface devices, compact disc (CD) drive, other non-transitory computer readable medium (CRM) drives).

Non-limiting examples of a computing device (502) include a general purpose computer (e.g., a personal computer, desktop, laptop, tablet, smart phone, etc.), a network device (e.g., switch, router, multi-layer switch, etc.), a server (e.g., a blade-server in a blade-server chassis, a rack server in a rack, etc.), a controller (e.g., a programmable logic controller (PLC)), and/or any other type of computing device (502) with the aforementioned capabilities. In one or more embodiments, a computing device (502) may be operatively connected to another computing device (502) via a network (500).

As used herein, “software” means any set of instructions, code, and/or algorithms that are used by a computing device (502) to perform one or more specific task(s), function(s) or process(es). A computing device (502) may execute software (e.g., via processor(s) (504) and memory (506)) which read and write to data stored on one or more persistent storage device(s) (508) and memory (506). Software may utilize resources from one or more computing device(s) (502) simultaneously and may move between computing devices, as commanded (e.g., via network (500)). Additionally, multiple software instances may execute on a single computing device (502) simultaneously.

In one or more embodiments, a processor (e.g., processor (504)) is an integrated circuit for processing computer instructions. In one or more embodiments, a persistent storage device(s) (508) (and/or memory (506)) may store software that is executed by the processor(s) (504). A processor (504) may be one or more processor cores or processor micro-cores.

In one or more embodiments, memory (e.g., memory (506)) is one or more hardware devices capable of storing digital information (e.g., data) in a non-transitory medium. In one or more embodiments, when accessing memory (506), software may be capable of reading and writing data at the smallest units of data normally accessible (e.g., “bytes”). Specifically, in one or more embodiments, memory (506) may include a unique physical address for each byte stored thereon, thereby enabling software to access and manipulate data stored in memory (506) by directing commands to a physical address of memory (506) that is associated with a byte of data (e.g., via a virtual-to-physical address mapping).

In one or more embodiments, a persistent storage device (e.g., persistent storage device(s) (508)) is one or more hardware devices capable of storing digital information (e.g., data) in a non-transitory medium. Non-limiting examples of a persistent storage device (508) include integrated circuit storage devices (e.g., solid-state drive (SSD), Non-Volatile Memory Express (NVMe), flash memory, etc.), magnetic storage (e.g., hard disk drive (HDD), floppy disk, tape, diskette, etc.), or optical media (e.g., compact disc (CD), digital versatile disc (DVD), etc.). In one or more embodiments, prior to reading and/or manipulating data located on a persistent storage device (508), data may first be required to be copied in “blocks” (instead of “bytes”) to other, intermediary storage mediums (e.g., memory (506)) where the data can then be accessed in “bytes”.

In one or more embodiments, a communication interface (e.g., communication interface (510)) is a hardware component that provides capabilities to interface a computing device with one or more devices (e.g., through a network (500) to another computing device (502), another server, a network of devices, etc.) and allow for the transmission and receipt of data with those devices. A communication interface (510) may communicate via any suitable form of wired interface (e.g., Ethernet, fiber optic, serial communication etc.) and/or wireless interface and utilize one or more protocols for the transmission and receipt of data (e.g., transmission control protocol (TCP)/internet protocol (IP), remote direct memory access (RDMA), Institute of Electrical and Electronics Engineers (IEEE) 801.11, etc.).

While a specific configuration of a system is shown, other configurations may be used without departing from the disclosed embodiment. Accordingly, embodiments disclosed herein should not be limited to the configuration of devices and/or components shown.

What is claimed is:

1. A method for generating composite prediction data, the method comprising:
obtaining, by a computing device, conventional prediction data based on historical revenue data;
generating first distributed prediction data, using a first distributed model, based on first sales pipeline data; and
obtaining a composite prediction data by aggregating the conventional prediction data and the first distributed prediction data.

2. The method of claim 1, wherein prior to obtaining the composite predication data, the method further comprises:
generating second distributed prediction data, using a second distributed model, based on second sales pipeline data.

3. The method of claim 2, wherein obtaining the composite prediction data further comprises:
aggregating the second distributed prediction data

4. The method of claim 3, wherein obtaining the composite prediction data, comprises:
assigning a first weight to the first distributed prediction data;
assigning a second weight to the second distributed prediction data;

5. The method of claim 4, wherein
the first weight is based on a first accuracy of the first distributed model, and
the second weight is based on a second accuracy of the second distributed model.

6. The method of claim 1, wherein prior to obtaining the conventional prediction data, the method further comprises:
selecting a first conventional model, wherein the conventional prediction data is generated using the first conventional model.

7. The method of claim 6, wherein prior to selecting the first conventional model, the method further comprises:
obtaining first historical conventional prediction data generated using the first conventional model;
obtaining second historical conventional prediction data generated using a second conventional model;
obtaining revenue data;
calculating a first error using the revenue data and the first historical conventional prediction data;
calculating a second error using the revenue data and the second historical conventional prediction data; and
making a determination that the first error is smaller than the second error, wherein selecting the first conventional model is based on the determination.

8. A non-transitory computer readable medium comprising instructions which, when executed by a processor, enables the processor to perform a method for generating composite prediction data, the method comprising:
obtaining, by a computing device, conventional prediction data based on historical revenue data;
generating first distributed prediction data, using a first distributed model, based on first sales pipeline data; and
obtaining a composite prediction data by aggregating the conventional prediction data and the first distributed prediction data.

9. The non-transitory computer readable medium of claim 8, wherein prior to obtaining the composite predication data, the method further comprises:
generating second distributed prediction data, using a second distributed model, based on second sales pipeline data.

10. The non-transitory computer readable medium of claim 9, wherein obtaining the composite prediction data further comprises:
aggregating the second distributed prediction data

11. The non-transitory computer readable medium of claim 10, wherein obtaining the composite prediction data, comprises:
assigning a first weight to the first distributed prediction data;
assigning a second weight to the second distributed prediction data;

12. The non-transitory computer readable medium of claim 11, wherein
the first weight is based on a first accuracy of the first distributed model, and
the second weight is based on a second accuracy of the second distributed model.

13. The non-transitory computer readable medium of claim 8, wherein prior to obtaining the conventional prediction data, the method further comprises:
selecting a first conventional model, wherein the conventional prediction data is generated using the first conventional model.

14. The non-transitory computer readable medium of claim 13, wherein prior to selecting the first conventional model, the method further comprises:
obtaining first historical conventional prediction data generated using the first conventional model;
obtaining second historical conventional prediction data generated using a second conventional model;
obtaining revenue data;
calculating a first error using the revenue data and the first historical conventional prediction data;
calculating a second error using the revenue data and the second historical conventional prediction data; and
making a determination that the first error is smaller than the second error, wherein selecting the first conventional model is based on the determination.

15. A computing device, comprising:
a processor; and
memory storing instructions which, when executed by the processor, enables the processor to perform a method for generating composite prediction data, the method comprising:
obtaining conventional prediction data based on historical revenue data;
generating first distributed prediction data, using a first distributed model, based on first sales pipeline data; and
obtaining the composite prediction data by aggregating the conventional prediction data and the first distributed prediction data.

16. The computing device of claim 15, wherein prior to obtaining the composite predication data, the method further comprises:
generating second distributed prediction data, using a second distributed model, based on second sales pipeline data.

17. The computing device of claim 16, wherein obtaining the composite prediction data further comprises:
aggregating the second distributed prediction data

18. The computing device of claim 17, wherein obtaining the composite prediction data, comprises:
assigning a first weight to the first distributed prediction data;
assigning a second weight to the second distributed prediction data;

19. The computing device of claim 15, wherein prior to obtaining the conventional prediction data, the method further comprises:
selecting a first conventional model, wherein the conventional prediction data is generated using the first conventional model.

20. The computing device of claim 19, wherein prior to selecting the first conventional model, the method further comprises:
obtaining first historical conventional prediction data generated using the first conventional model;
obtaining second historical conventional prediction data generated using a second conventional model;
obtaining revenue data;
calculating a first error using the revenue data and the first historical conventional prediction data;
calculating a second error using the revenue data and the second historical conventional prediction data; and
making a determination that the first error is smaller than the second error, wherein selecting the first conventional model is based on the determination.
